(19) United States
(12) Patent Application Publication
(10) Pub. No.: US 2007/0058856 A1
(43) Pub. Date: Mar. 15, 2007

(54) Character recoginition in video data

(75) Inventors: Lokesh R. Boregowda, Bangalore (IN); Anupama Rajagopal, Coimbatore (IN)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/227,016

(22) Filed: Sep. 15, 2005

(51) Int. Cl. G06K 9/62; G06K 9/18; G06K 9/34; G06K 9/00

(52) U.S. Cl. 382/159; 382/182; 382/173; 382/105

(57) ABSTRACT

An example method of recognizing characters in video data includes (i) Obtaining a binary image from a scene in video data; (ii) segmenting characters in the binary image (e.g., by using region labeling); and (iii) using a character recognition model to recognize the segmented characters. The method may be incorporated into an existing video system or newly developed video systems to perform character recognition tasks on a variety of different objects. In some embodiments, the character recognition module uses a learning-based neural network to recognize characters. In other embodiments, the character recognition module uses a non-learning-based progressive shape analysis process for character recognition.

### TECHNICAL FIELD

The present invention relates to the field of video processing, and in particular to recognizing characters in video data.

### BACKGROUND

Recent technological advances have made it possible to automate a variety of video surveillance applications. As an example, video surveillance may be used to automatically authenticate vehicles that move in and out of parking lots.

A variety of vision systems are used to read characters on objects that are captured in video data (e.g., a license plate). These systems typically include a module that localizes the license plates, a module that segregates the characters on the license plates into segments, and a module that recognizes a character in each segment.

The characters need to be accurately segmented in order for the character in each segment to be recognized. Segmenting characters is one of the more difficult issues relating to character recognition within video data. Most recognition-related errors in conventional systems are due to errors that occur during segmentation of the characters as opposed to reading the characters themselves. The difficulties with segmentation arise when there is limited resolution and/or clarity of the characters (e.g., due to dirt, scratches, shadows, poor illumination, improper focus and skew).

Character recognition is typically performed using a statistical classifier that includes a convolution network. The convolution network usually obtains a confidence score that relates to the probability of properly identifying each character. The classifier is trained by employing virtual samples of characters and then comparing characters to predetermined conventions in order to check accuracy of recognition. The comparison is continued until the confidence score for each character exceeds a threshold value.

Some vision systems also utilize template matching as part of the character recognition process. Template matching at least partially applies to segmented regions that are enclosed by rectangles with connected components in the regions having an average size. When a segmented region is recognized by the convolution network with a lower then desired confidence score (or level), the segmented region placed into a binary form and then scaled to the same size as the templates in a database (e.g., 15×25 pixels or 20×30 pixels).

A normalized matching index with a range from −1 to 1 is usually defined as the confidence measure that is obtained by a pixel-to-pixel comparison between the reference character and the character that is being analyzed. As the confidence measure approaches 1, the analyzed character implies a perfect match with a reference character. A threshold confidence measure (e.g., greater than 0.5) is sometimes chosen to filter out particular characters that do not match reference characters.

One of the drawbacks with template matching is that it requires exhaustive searching of a stored database that includes a variety of character images (i.e., different sizes and styles of the same character). In addition, a typical stored database is quite large such that extensive computing power is required to search the database and perform any calculations that are required to analyze a character.

There are some vision systems that utilize a segmentation-free approach to analyzing characters. Some segmentation-free approaches are based on the recognition of homeomorphic sub-graphs to previously defined prototype graphs of characters. Each sub-graph is analyzed to find a match to a previously defined character prototype. The recognized sub-graph is typically identified as a node in a directed net that compiles different alternatives of interpretation for the characters in the entire graph. A path in the net usually represents a consistent succession of characters.

Segmentation-free approaches place a major emphasis on obtaining an accurate classification by employing very sophisticated estimation techniques. One of the drawbacks with these types of estimation techniques is that they require extensive computing capacity. In addition, the features that are typically extracted during some segmentation-free approaches are considered to be secondary which can lead to an inaccurate analysis of characters.

### BRIEF DESCRIPTION OF THE DRAWINGS

FIG. 1 illustrates a flowchart of an example method of recognizing characters in video data.

FIG. 2 illustrates an example image of an automobile where a license plate is visible in the image of the automobile.

FIG. 3 shows an image of the license plate that is shown in FIG. 2 extracted from the image of the automobile shown in FIG. 2.

FIG. 4 illustrates a binary image of the license plate that is shown in FIG. 3.

FIG. 5 shows the binary image of FIG. 4 where the characters in the license plate have been segmented.

FIG. 6 illustrates a flowchart of a character recognition module that uses a learning-based neural network to recognize characters.

FIG. 7 illustrates a sub-pattern of 5×5 pixels that may used in an example neural network.

FIG. 8 illustrates a portion of an example recognition neural network that includes four layers excluding the input layer.

FIG. 9 illustrates a sample result from an example user interface where the user interface depicts a rule-based recognizing method for a particular type of license plate.

DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention relates to a method of recognizing characters on an object that is captured in video data. As examples, the video data may have captured characters on vehicle license plates or characters that are on labels which identify containers.

The functions or algorithms described herein may be implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

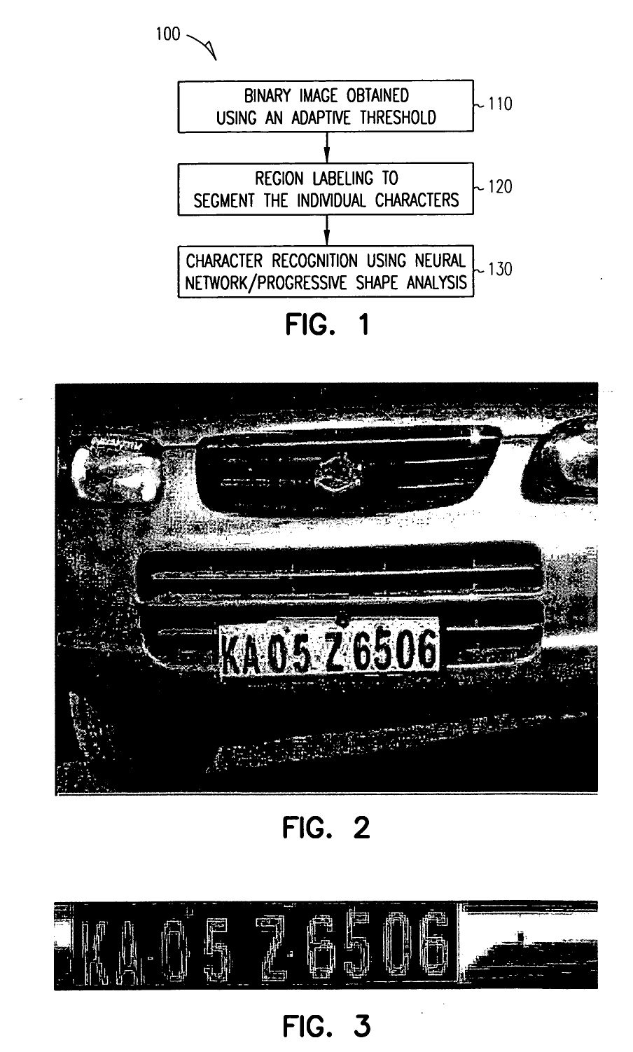

FIG. 1 shows a flowchart 100 of an example method of recognizing characters in video data. The method includes (i) 110 obtaining a binary image from a scene in video data; (ii) 120 segmenting the characters in the image (e.g., by using region labeling); and (iii) 130 using a character recognition module to recognize the segmented characters. The methods described herein may be incorporated into an existing video system or newly developed video systems to perform character recognition tasks on a variety of different objects.

In some embodiments, the binary image may be obtained using an imaging module. In addition, the characters may be segmented by a segmentation module.

As an example, an image of a license plate may be detected from a scene in video data using an imaging module that standardizes the size of the image (e.g., 50×400). [INVENTOR—PLEASE DESRIBE HOW IT IS DETERMINED THAT A SCENE CONTAINS CHARACTERS THAT NEED TO BE RECOGNIZED]. The image may then be placed into a binary form using an adaptive threshold that is formed from a histogram of the image. Placing the object (e.g., license plate, label) that is being analyzed at a standard size facilitates the process of segmenting the characters.

The individual characters within the image may be segmented by a segmentation module that uses region labeling. In some embodiments, heuristics-based analysis may be done on the segmented characters to remove the non-character elements. Each segmented character may then be standardized to a size of 32×32 so as to have a standard input to the classifier as described below.

FIG. 2 illustrates an example image of an automobile where a license plate is visible in the image of the automobile. FIG. 3 shows an image of the license plate that is shown in FIG. 2 with the license plate extracted from the image of the automobile. The image of the license plate may be segmented from the image of the automobile using row and column projection histograms on the difference images. The license plate should be extracted accurately from the image of the automobile in order for the characters on the license plate to be recognized.

The extracted image of the license plate may contain some regions that do not include characters. The extracted image needs to be placed in binary form so that the characters may be individually recognized on the license plate.

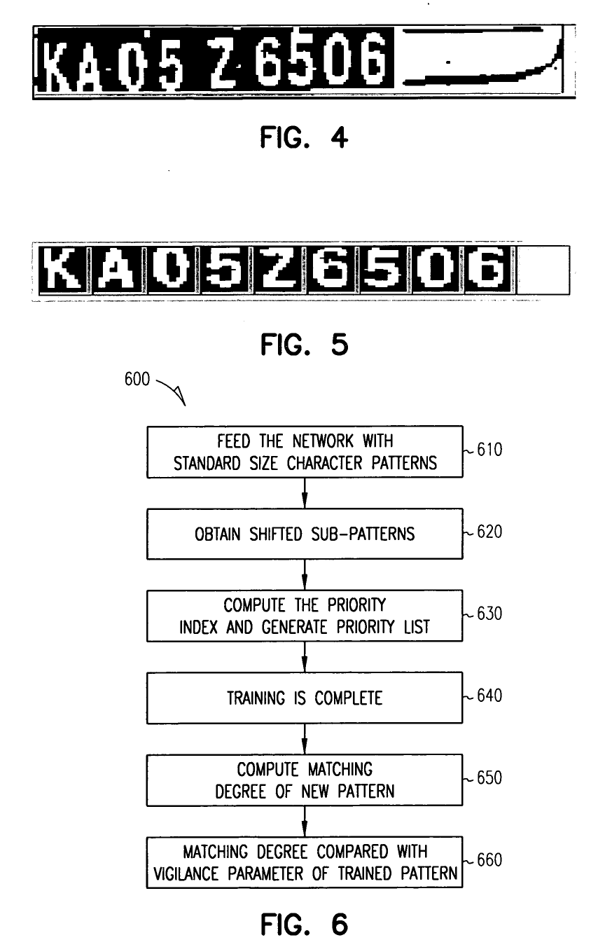

The extracted image may be resized to a standard size (e.g., 50×400, which is a typical size of a license plate). Adaptive thresholding may then be done to the extracted image to place the extracted image (e.g., license, label) into binary form (see FIG. 4). Adaptive thresholding of the extracted image is desirable since the illumination of the automobile (or other item) in the scene may vary from one image to another image.

The adaptive threshold is selected based on the histogram profile of the segmented image. This adaptive threshold helps to reduce the effect of illumination conditions as the image is placed into binary form.

FIG. 5 shows the binary image of FIG. 4 where the characters have been segmented and everything except the characters have been removed from the binary image. The individual characters may be segmented by utilizing a region labeling approach that includes connected component analysis. In addition, heuristics-based analysis may be done to remove everything except the characters from the binary image. The extracted characters may then be zoomed to a standard size (e.g., 32×32) before being analyzed by the character recognition module. Accurately segmenting the characters is an important part of being able to recognize the characters.

In some embodiments, the character recognition module uses a learning-based neural network to recognize characters. The neural network based character recognition module may be a two-layer feed forward neural network that uses self generated shifted sub-patterns for improved training of the neural network.

In other embodiments, the character recognition module uses a non-learning-based progressive shape analysis process for character recognition. The progressive analysis based character recognition module uses relative shape information for characters that may be computationally less intensive when compared to the existing methods which use template matching and contour based analysis for character recognition.

FIG. 6 is a flowchart 600 that illustrates a portion of an example character recognition module which uses a learning-based neural network to recognize characters. As an example, a set of patterns may be used to train (i.e., optimize) and obtain the weights of the network. The set of patterns may be 610 feed to the network with standard size character patterns. Each pattern consists of a feature vector, along with either a class or a target vector.

A feature vector is a tuple of floating-point numbers that is typically extracted from various kinds of patterns that represent characters. An upper bound is set on the number of training patterns for a character so that the learning-based neural network does not “memorize” the character.

Once the patterns are determined, 620 shifted sub-patterns are generated for each pattern. Shifted sub-patterns are used to account for deformation and noise.

The shifted sub-patterns may be used to 630 compute priority indices and/or to generate a priority list. Once the priority indices and/or priority lists are generated, 640 the network training may be complete. A matching degree is then 650 computed for each new pattern and a new subnet is created (if necessary).

During operation of the character recognition module, 660 the matching degree of the pattern to be recognized is compared with the vigilance parameters of the patterns in the priority list. The pattern is classified as belonging to the class of the first pattern in the priority list whose vigilance parameter is lower than its corresponding matching degree. A class denotes the actual class to which the object belongs (e.g., a character that is in the form of a handwritten symbol). Training may be completed by storing the final values of the network weights as a file.

The neural network performs testing by sending a set of patterns through the neural network. The output values (i.e., the hypothetical classes for a classifier network), or produced output vectors, are compared with target classes or vectors and the resulting error rate is calculated.

One strategy for training a neural network on a new classification problem is to first work with a single training/testing session and survey different combinations of parameter settings until a reasonable amount of training is achieved (e.g., within the first 50 iterations). This type of single training/testing session may involve using a relatively high value for regularization and varying the number of hidden nodes in the network.

As an example, about eight patterns of each character may be trained and their weights collected. Increasing the number of patterns comes closer to creating an exact match of the characters.

In some embodiments, a user interface may be provided that allows a user to get the image of the car and then extract an image of the license palate out of the image of the car. The training for the characters may be done offline such that the character are recognized and then displayed or used in some other manner (e.g., for identification).

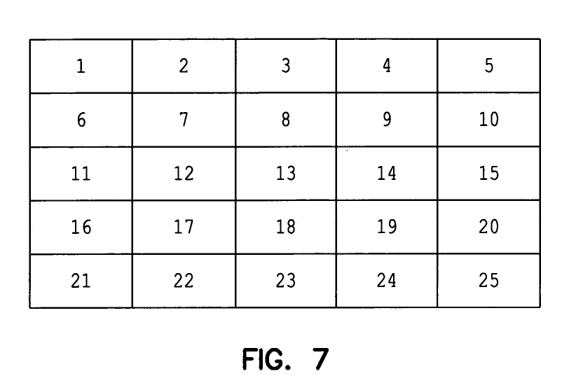

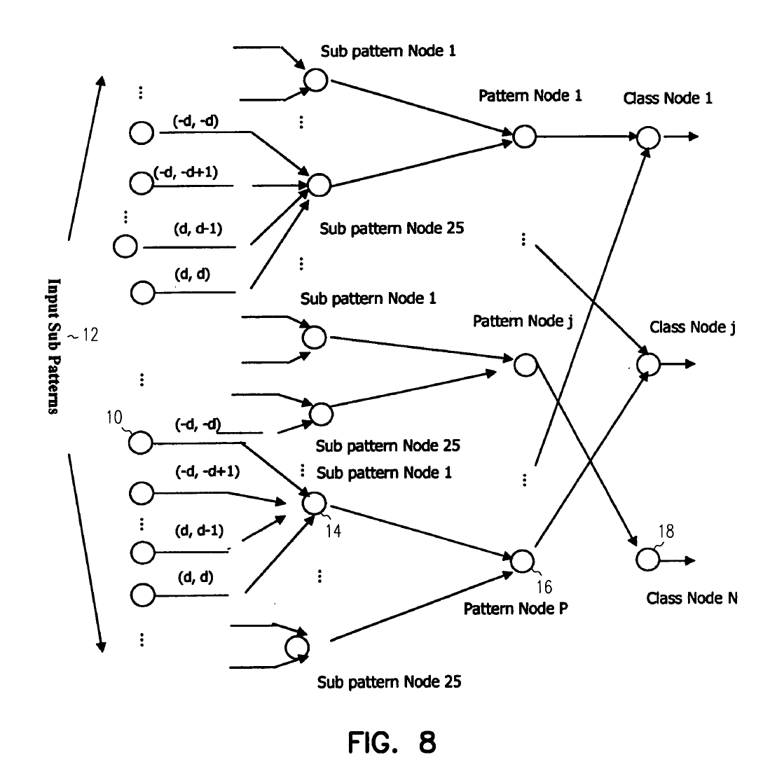

The operation of a character recognition module that includes an example neural network will now be described with reference to FIGS. 7 and 8. Some recognition neural networks create distinct subnets for every training pattern given as input. This amount of input drastically increases the overall size of the network when all alphabets and numerals (along with their variations) are included.

The neural network architecture described herein improves on this concept because training patterns are merged based on a measure of similarity among features. A subnet is shared by similar patterns. A minimal number of subnets are learned automatically to meet accuracy criteria. Therefore, the network size can be reduced and human experts need not pre-select training patterns. In addition, the fusion of training patterns increases the recognition rate of the network.

The input pattern may an array of 20×20 pixels, which are numbered 1, 2, 3 . . . 400 from left to right and top to bottom. A set of 5×5 pixels is called a sub-pattern and the sub-patterns are numbered 1, 2, 3 . . . 25 (see FIG. 7).

A sub-pattern j is called a nominal sub-pattern if it contains the following pixels—
[(j−1)/4]*80+(k−1)*20+[(j−1)%4]*4+i
1≦k≦5, 1≦i≦4

As an example, the 6th nominal sub-pattern would contain pixels, 81, 82, 83, 84, 101, 102, 103, 104, 120, 121, 122, 123, 124, 140, 141, 142, 143, and 144. A sub-pattern with the coordinate (c1x, c1y) of the center pixel is said to have a distance ‘h’ from another sub-pattern with the coordinate (c2x, c2y) of the center pixel, if,
Max(|c1x−c2x|, |c1y−c2y|)=h.

The former sub-pattern is said to be (c1x−c2x, c1y−c2y) units away from the latter sub-pattern.

The example recognition neural network may include at least four layers (excluding the input layer) as shown in FIG. 8. Sub-patterns (see, e.g., sub-pattern 10) of an input pattern 12 are presented to the shift-sub-pattern layer. Shift-sub-pattern nodes (see, e.g., shift-sub-pattern node 14) take care of the deformation (i.e., shift, noise or size) of the input pattern. The sub-pattern node may summarize the measure of similarity between the corresponding input sub-pattern and the stored sub-pattern. A pattern node in the pattern layer reflects the similarity measure between the input pattern and the stored pattern. A pattern node may be connected to one category node in the category layer (class layer) indicating the class of the input pattern. As described herein, class refers to the character where the pattern belongs.

A sub-pattern node is responsible for the match between an input nominal sub-pattern and the stored sub-pattern. However, in order to compensate for possible deformation of the input pattern, the sub-patterns neighboring an input nominal sub-pattern may have to be considered. Suppose a deformation of up to ±d (d is a positive integer) pixels in either X or Y directions is allowed. All the neighboring sub-patterns within the distance d may have to be considered in order to detect possible deformation. Each neighboring sub-pattern is taken care of in a shift-sub-pattern node. Therefore, a sub-pattern node may receive the outputs of up to (2d+1) 2 shift-sub-pattern nodes. As an example, the first sub-pattern node may have (d+1) 2 shift-sub-pattern nodes, and the sixth sub-pattern node may have (2d+1) 2 shift-sub-pattern nodes.

Each sub-pattern node may store a node weight W that is shared by all its shift-sub-pattern nodes. A shift-sub-pattern node computes, based on the input pattern and its node weight, a value and outputs the value to the associated sub-pattern node. The value computed by a shift-sub-pattern node measures the similarity between an input sub-pattern with distance (sx, sy), −d≦sx≦d, −d≦sy≦d, from the underlying input nominal sub-pattern and the node weight stored in the sub-pattern node. A sub-pattern node investigates the output values of all its shift-sub-pattern nodes and takes the maximum of them as its output.

The third layer contains pattern nodes (see, e.g., pattern node 16). 25 sub-pattern nodes (see, e.g., sub-pattern node 18) link a pattern node, with a link weight, ω associated with each link. A vigilance parameter (ρ, 0≦ρ≦1) is also associated with each pattern node. The values of vigilance parameters may be adjusted in the training phase of the network (described later). The vigilance parameters control the accuracy of classifying input training patterns. Each pattern node receives values from all its sub-pattern nodes and computes a number from these values. The numbers from all pattern nodes are involved in triggering one of the class nodes to indicate that the input pattern has been appropriately classified.

The following notation is used herein to refer to nodes. Nᵢ refers to a pattern node. Then N_{i,j} denotes the jth sub-pattern node of Nᵢ and N_{i,j}(sx, sy) denotes the shift-sub-pattern node of N_{i,j} that takes care of the input sub-pattern which is (sx, sy) away from the nominal sub-pattern. A positive (negative) sx, denotes a right (left) shift, and a positive (negative) sy denotes a down (up) shift of the sub-pattern. The notation N_{i,j,} (sx, sy) is referred to as the (sx, sy) shift-sub-pattern node of N_{i,j}. A subnet of a pattern node Nₖ is defined to be the sub-network consisting of the pattern node Nₖ, its sub-pattern nodes and shift-sub-pattern nodes, together with all the associated links.

As part of network creation and training a set of training patterns may be given. Each pattern is represented by a row matrix A of 400 pixels, and each sub-pattern by a row matrix Iⱼ of 16 pixels, 1≦j≦16, namely,
Iⱼ=[Iⱼ₁, Iⱼ₂ , . . . Iⱼ16], 1≦j≦25
A=[I₁, I₂, . . . I₂₅]

Where Iⱼₖ is the normalized gray level of the corresponding pixel (i.e., Iⱼₖ ε{−1, 1}), −1 may be used for representing black and 1 for representing white. For convenience, the input to a shift-sub-pattern node N_{i,j}(sx, sy) is represented by Iⱼ(sx, sy). I (0, 0) may be abbreviated as Iⱼ.

Each sub-pattern node stores a node weight, W shared by all its shift-sub-pattern nodes. For a sub-pattern node N_{i,j,} its node weight W_{i,j} is defined to be
W_{i,j}=[W_{i,j}1, W_{i,j}2, . . . , W_{i,j}16 ]
Where each W_{i,j,}k, 1≦k≦16, is an integer. Suppose an input training pattern A with class C is presented to the network. Each shift-sub-pattern node N_{i,j}(sx, sy) computes its output O_{i,j}(sx, sy) by
O_{i,j}(sx, sy)=W_{i,j}*I^{T}ⱼ(sx, sy) Σ|W_{i,j} k|

The superscript T stands for matrix transposition. Since each element of I^{T}ⱼ(sx, sy) is either 1 or −1, the following relationship holds:
−Σ|W_{i,j,} k|≦W_{i,j}*I^{T}ⱼ(sx, sy)≦Σ|W_{i,j} k|

Therefore, −1≦O_{i,j}(sx, sy)≦1O_{i,j}(sx, sy) measures the similarity between Ij (sx, sy) and the node weight W_{i,j} stored in N_{i,j}. The more Iⱼ(sx, sy) is similar to the stored weight W_{i,j} the closer O_{i,j}(sx, sy) is to 1. On the contrary, the more Iⱼ(sx, sy) is different to the stored weight W_{i,j} the closer O_{i,j}(sx, sy) is to −1. All the outputs of shift-sub-pattern nodes are sent to respective sub-pattern nodes. Each sub-pattern node N_{i,j} takes the maximum value of all its inputs, i.e.,
O_{i,j}=max(O_{i,j}(−d, −d) . . . O_{i,j}(0, 0) . . . O_{i,j}(d, d)).

This value, O_{i,j} sent to its pattern node Nᵢ. The way O_{i,j} is computed reflects the spirit of recognition by parts. Also, this accounts for the tolerability of MFRNN on deformation, noise, and shift in position.

The priority index Pᵢ for a pattern node Ni is defined by,
Pᵢ=Σ(3*O_{i,j}−2)1/3 1≦j≦25.

Using priority indexes may make the training procedure more efficient. The priority indices of all pattern nodes are sorted in decreasing order and placed in the priority list. Suppose the largest priority index in the priority list is Pₖ. Let the pattern node corresponding to Pₖ be Nₖ, the class for Nₖ be Cₖ, and Nₖ's vigilance be ρₖ. The following matching degree Mₖ for Nₖ is computed—

$${M}_{k} = \frac{Σ ( {ω}_{k , j} \hat{} {O}_{k , j} + 1 )}{Σ ( {ω}_{k , j} + 1 )}$$

Where ω_{k,j} is the link weight between Nₖ and N_{k,j}. The operator ˆ is defined as the ‘minima’ operator, i.e., aˆb=min (a, b).

Since ω_{k,j}ˆO_{k,j}≦ω_{k,j} and −1≦ω_{k,j}0≦Mₖ≦1. Mₖ reflects the similarity between the input pattern A and the pattern stored in the subnet of Nₖ in a global sense; the more similar they are, the larger Mₖ we have. Then we have the following cases—

i) If Mₖ≧ρₖ and C=Cₖ, then the pattern stored in the subnet of Nₖ is modified by changing the associated node weights and link weights as follows—
W_{k,j}←W_{k,j}+Iⱼ(sx, sy), 1≦j≦25.
ω_{k,j}←ω_{k,jˆ}O_{k,j} 1≦j≦25.

Where Iⱼ(sx, sy) is the input to N_{k,j}(sjx, sjy) whose output value to N_{k,j} is the largest among the shift-sub-pattern nodes of N_{k,j}. Then the input training pattern A has been taken into account. The above equation intends to increase the output value of N_{k,j}(sjx, sjy) more than the output values of the other shift-sub-pattern nodes of N_{k,j} when an identical input pattern is presented to the network next time.

If Mₖ≧ρₖ and Mₖ<1, then ρₖ is increased as follows—
ρₖ←Mₖ+β

Where β is very small positive real number. With this increase in ρk, the next time when an identical input pattern is presented to the network, Mk would be no longer greater than or equal to ρk.

ii) If Mₖ≧ρₖ and Mₖ=1, then the modification becomes—
ρₖ←1
ω_{k,j}←O_{k,j}+β, 1≦j≦25,
where β is a very small positive real number. In this case, Mₖ would be slightly less than ρk the next time when an identical input pattern is presented to the network, since the numerator of equation (4) takes the smaller of ω_{k,j} & O_{k,j}.

iii) If Mₖ is smaller than the vigilance ρₖ of Nₖ, then the subnet of Nₖ is not modified.

If any of the last three cases (cases 2, 3, 4) occurs, the next highest priority index in the priority list is selected and the above process is continued iteratively until either the first case occurs or every member of the priority list is considered. If the first case has never occurred, then it means that the training pattern should not be combined in any existing pattern subnet. In this case, a new pattern subnet is created for storing this training pattern. Let Nₙ be the pattern node of this new subnet. The node weight Wₙ, j of the jth sub-pattern node of Nₙ is initialized by
W_{n,j}←Iⱼ, 1≦j≦25
and the jth link weight, ω_{n,j} of Nₙ is initialized to 1, namely,
ωₙ, j←1, 1≦j ≦25
and the vigilance ρₙ associated with Nₙ is set to an initial value which depends on how much degree of fuzziness is allowed for Nₙ to include in the subnet the other input patterns. This value is chosen to be 0.45 for the current application. If the network already contains a class node for C, then Nₙ is connected to this class node, otherwise a class node for C is created and Nₙ is connected to it.

Priority indexes help the training process in a variety of ways. As an example, for a training pattern A with class C, if no class node of C exists in the network, then the above procedure is not required at all. A new subnet is then created by applying one or more of the equations described above. Next time when an identical pattern is presented this subnet will get activated since it will be the first element in the priority list. This treatment of the new subnet will not cause any problem for the recognition phase since priority indexes are applied in the same way as described in the next section.

Two or more pattern nodes may connect to an identical class node indicating that the patterns stored in these subnets are in the same class. This case occurs if training patterns of a class are clustered in groups. The patterns in one cluster may be made similar enough to the patterns in another cluster (as measured by matching degrees). As a result, each cluster results in a different subnet. The above procedure is iterated with the training pattern set until the network is stable (i.e., none of the vigilance in the network changes).

Once training is complete, the network may be ready for recognizing unknown patterns. Suppose A is a normalized input pattern that is presented to the trained network. First, the priority indexes of all pattern nodes are computed. These indexes are sorted in decreasing order in the priority list. Suppose the largest priority index in the priority list is Pₖ. Let the pattern node corresponding to Pₖ be Nₖ, the class of Nₖ be Cₖ, and Nₖ's vigilance be ρk. Then the matching degree Mₖ is computed for Nₖ.

If Mₖ is greater than or equal to ρₖ then the input pattern is classified to Cₖ. If Mₖ is less than ρₖ, then the next highest priority index in the priority list is selected and the above process is continued iteratively. If a pattern node with the matching degree being greater than or equal to its vigilance is not found, then we classify the input pattern to the class represented by the class node connected by the pattern node with the highest priority index.

The operation of a character recognition module that uses a progressive analysis of relative shape information to recognize characters will now be described. The progressive analysis of a relative shape approach may be a simple and efficient way of recognizing characters from the binary segmented character images. In addition, the progressive analysis of a relative shape approach may be more robust and require less intense computation as compared to existing methods that use template matching and contour based analysis for character recognition.

The progressive analysis of relative shape approach employs contour tracing and repeated analysis of the traced contour. The contour of the character images are analyzed in different ways such that the character may be identified.

As an example, the contour pixels of the character images may be grouped into different curve shapes (e.g., holes, arcs, etc.). The different curve shapes are analyzed (e.g., by determining like number of holes, position of holes, position of arcs, orientation of arcs) in order to identify a character.

The shape of a binary image is analyzed by getting a contour map of the image. The contour map is obtained by checking 4-connectivity of the pixels. As an example, if a foreground pixel has 4-connectivity with same type of pixels, then it is considered as an inside pixel and is not included in the contour map. In addition, if at least one of the 4 neighbors is a background pixel, then the pixel is considered as edge pixel and is included in the contour map.

Next, the contour map is checked for the presence of holes. The presence of holes inside the contour is determined by stripping off the outer contour pixels and analyzing whether there are any residual contour pixels present inside the character. After finding the number of holes inside the outer contour, the binary image is classified broadly into three character categories:

1. Two-hole character (B and 8).

2. One-hole character (A, D, 0, 9, etc.).

3. No-hole character (C, E, 2, etc.).

The recognition phase assumes that the license plate reader employs a rule-based engine that classifies the input character image into either an alpha character or a numeric character. Therefore, character recognition is performed separately for alpha characters and numeric characters.

The recognition of two-hole characters is relatively simple as there is only one alpha character (B) and numeric character (8). The remaining two groups are divided into sub-groups by progressively analyzing the shape information from the contour map.

The characters in the one-hole group are classified based on the size of the hole and the position of the hole. If the height of the hole inside the character is greater than half of the image height, then it is grouped into D, O and Q group (referred to as D-group). If the character has a straight line at the left of image, the image is classified as D. In addition, if the character has more foreground pixels at the bottom than at the top, the image is classified as Q. Otherwise, the character is classified as O.

If the height of the hole is less than half of image height, the character is grouped into A, P and R group (referred as A-group). If the character has a considerable number of pixels at the right bottom, then it is grouped into A and R group (referred as A-subgroup). Otherwise, the image is classified as P.

With regard to the A-subgroup, if the character has a vertical line on the left side of image, the image is classified as R. Otherwise, the image is classified as A.

No-hole characters are sub divided into smaller groups by analyzing the shape features progressively until each character is classified separately. The contour of the characters are searched for open arc-like shapes and are classified into different sub groups depending on the direction of the open arc shapes (i.e., left, right, top and bottom) and their relative positions and combinations.

If the contour has an open arc shape on the top only, then the image is grouped into U, V and Y group (referred as U-group). The characters inside the U-group are individually classified by finding a vertex in the contour. If the character does not have a vertex, the image is classified as U. If the character has a vertex in the bottom portion of the image it is classified as V. In addition, if the vertex lies in the middle portion of image, the character is classified as Y.

If the contour has an open arc shape on the right only, then the image is grouped into C, E, F and G group (referred as C-group). If the character inside the C-group has three arms, the image is sub classified into a group of E and G (referred as E-subgroup). Any others characters are placed in a group of C and F (referred as C-subgroup).

The characters in the E-subgroup are divided into four quadrants such that if the number of foreground pixels in the 4th quadrant is greater than 50% of the total number of pixels in that quadrant, then the character is classified as G. Otherwise, the character is classified as E.

The characters in the C-subgroup are checked for foreground pixels in the bottom right portion of image. If the number of foreground pixels crosses the threshold it is declared as C. Otherwise, the character is classified as F.

If the contour has open arc shapes on both top and bottom sides, then the image is grouped into H, M, N and W group (referred to as H-group). If a character inside the H-group has three arms in it, the image is sub classified into a group of M and W (referred to as M-subgroup). Any other characters are placed into a group of H and N (referred as H-subgroup).

The characters in the H-subgroup are checked to see if the arc vertex of both arcs (top and bottom) lies on same side of image, then the character is classified as H. Otherwise, the image is classified as N.

The characters in the M-subgroup are checked if the character has a third arm from the top, then the image is classified as M. If the image has a third arm extending from the bottom, then the character is classified as W.

If the contour has open arc shapes on both left and right sides, then the character is grouped into S and Z group (referred as S-group). The characters in the S-group are checked to see if the arc vertex of a left arc lies on top of an arc vertex of a right arc, then the image is classified as Z. If the vertices of the arcs are arranged the other way, then the image is classified as S.

If the contour has open arc shapes on the top, bottom and right sides then the image is classified as character K. If the contour has open arc shapes on all sides (i.e., top, bottom, left and right), then the image is classified as character X.

When a character is not classified in one of the above tests, the image is divided into four parts height-wise with full width. If the number of foreground pixels in the top part is greater than that of bottom one, then the image is classified as T. Otherwise, the character is grouped into an L and J group (referred as L-group).

The characters in the L-group are checked and if the total number of foreground pixels in the left half of the image is greater than that of right half, then the character is classified as L. Otherwise, the image is classified as J.

### Experimental Results

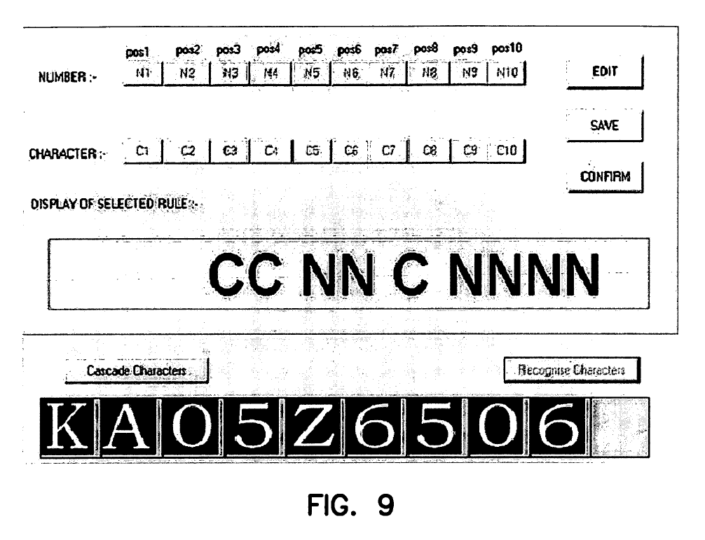

A sample result from a user interface is shown in FIG. 9. The example user interface depicts a rule-based recognizing method where the rule may be formed for a particular license plate by selecting alpha or numeric button controls. Once a particular set of rules is selected, the set of rules is applicable to all the successive license plates (or labels) until the rule is changed to suit another type of license plate. Therefore, license plates of different locations with varying numbers and locations of alpha and numeric characters can be recognized. FIG. 9 shows a rule for a license plate having nine characters with the position of the letters and numbers as shown in the selected rule.

While the invention has been described in detail with respect to the specific aspects thereof, it will be appreciated that those skilled in the art, upon attaining an understanding of the foregoing, may readily conceive of alterations to, variations of, and equivalents to these aspects which fall within the spirit and scope of the present invention, which should be assessed accordingly to that of the appended claims.

1. A computer implemented method comprising:
obtaining a binary image from a scene in video data;
segmenting characters in the binary image; and
using a character recognition module to recognize the segmented characters.

2. The computer implemented method of claim 1, wherein segmenting characters in the binary image includes segmenting the characters in the binary image by using region labeling.

3. The computer implemented method of claim 2, wherein using region labeling includes using connected component analysis.

4. The computer implemented method of claim 1, wherein segmenting characters in the binary image includes removing everything except the characters from the binary image.

5. The computer implemented method of claim 4, wherein removing everything except the characters from the binary image includes performing heuristics-based analysis on the binary image.

6. The computer implemented method of claim 1, wherein segmenting characters in the binary image includes zooming the segmented characters to a standard size before using the character recognition module.

7. The computer implemented method of claim 6, wherein zooming the segmented characters to a standard size includes zooming the segmented characters to 32×32.

8. The computer implemented method of claim 1, wherein obtaining a binary image from a scene in video data includes extracting an image from a larger image where the extracted image includes the characters that get segmented.

9. The computer implemented method of claim 8, wherein obtaining a binary image from a scene in video data includes placing the extracted image into binary form by resizing the extracted image to a standard size and then adaptive thresholding the extracted image.

10. The computer implemented method of claim 9, wherein adaptive thresholding the extracted image includes selecting the adaptive threshold based on the histogram profile of the extracted image such that the adaptive threshold helps to reduce the effect of illumination conditions as the image is placed into binary form.

11. The computer implemented method of claim 1, wherein using a character recognition module to recognize the segmented characters includes using a neural network based character recognition module.

12. The computer implemented method of claim 11, wherein using a neural network based character recognition module includes using a two-layer feed forward neural network based character recognition module.

13. The computer implemented method of claim 11, wherein using a neural network based character recognition module includes using self-generated shifted sub-patterns for improved training of the neural network.

14. The computer implemented method of claim 1, wherein using a character recognition module to recognize the segmented characters includes using a progressive analysis based character recognition module.

15. The computer implemented method of claim 14, wherein using a progressive analysis based character recognition module includes using relative shape information for characters in order to analyze the binary segmented character images.

16. The computer implemented method of claim 14, wherein using a progressive analysis based character recognition module includes grouping contour pixels of each binary segmented character image into different curve shapes.

17. A machine readable medium including instructions thereon to cause a machine to execute a process comprising:
obtaining a binary image from a scene in video data;
segmenting characters in the binary image; and
using a character recognition module to recognize the segmented characters.

18. The machine readable medium of claim 17, wherein segmenting characters in the binary image includes zooming the segmented characters to a standard size before using the character recognition module.

19. The machine readable medium of claim 17, wherein using a character recognition module to recognize the segmented characters includes using a two-layer feed forward neural network based character recognition module that utilizes self-generated shifted sub-patterns for improved training of the two-layer feed forward neural network.

20. The machine readable medium of claim 17, wherein using a character recognition module to recognize the segmented characters includes using a progressive analysis based character recognition module to group contour pixels of the binary segmented character images into different curve shapes and then analyzing the contour pixels using relative shape information.

21. A system comprising:
an imaging module that obtains a binary image from a scene in video data;
a segmentation module that segments characters in the binary image that is received from the imaging module; and
a character recognition module that recognizes the segmented characters that are received from the segmentation module.

22. The system of claim 21, wherein the segmentation module zooms the segmented characters to a standard size before the character recognition module recognizes the segmented characters.

23. The system of claim 21, wherein the character recognition module includes a two-layer feed forward neural network based character recognition module that utilizes self-generated shifted sub-patterns for improved training of the two-layer feed forward neural network.

24. The system of claim 21, wherein the character recognition module includes a progressive analysis based character recognition module that groups contour pixels of the binary segmented character images into different curve shapes and then analyzes the contour pixels using relative shape information.
